(19) United States
(12) Patent Application Publication
(10) Pub. No.: US 2013/0278725 A1
(43) Pub. Date: Oct. 24, 2013

(54) Integrated Structured Light 3D Scanner

(71) Applicant: CONNECTICUT CENTER FOR ADVANCED TECHNOLOGY, INC., East Hartford, CT (US)

(72) Inventors: Muhammad Nasir Mannan, Middletown, CT (US); Thomas W. Scotton, Middletown, CT (US)

(73) Assignee: Connecticut Center for Advanced Technology, Inc., East Hartford, CT (US)

(21) Appl. No.: 13/869,859

(22) Filed: Apr. 24, 2013

Related U.S. Application Data
(60) Provisional application No. 61/637,367, filed on Apr. 24, 2012.

(51) Int. Cl. G06F 17/50; H04N 13/02

(52) U.S. Cl. CPC G06F 17/5086; H04N 13/0203
USPC 348/46

(57) ABSTRACT

A modular, flexible 3D scanner is provided which integrates motion control, data acquisition, data processing and report generation functions in a system having a single user interface for all functions. Control software includes an interface and components to assist a user in creating motion control scripts that are used to move a part through various positions at which images are captured. Analysis software is called from the control software to process data into an accurate 3D rendering of the part, which is compared to a virtual model of the part as designed. A report is generated showing where the measured dimensions of the part vary from the as designed dimensions of the part. The disclosed 3D scanner can be used in conjunction with a CNC machine to provide on-machine inspection to reduce rework, labor and scrap.

### FIELD OF THE DISCLOSURE

The present disclosure relates to the field of three dimensional (3D) imaging and more particularly to structured light 3D scanning.

### BACKGROUND

Three dimensional (3D) imaging is used to create computerized 3D renderings of objects which can be used for reverse engineering and for non-contact inspection of manufactured parts. To generate a 3D file of an object, the object is illuminated and imaged by a camera from several points of view. Software is commercially available to interface with the camera to capture and translate the image data into a 3D point cloud for each point of view, resulting in several 3D point cloud data sets. A second commercially available software integrates the several 3d point cloud data sets into a 3D image of the object.

Commercially available 3D scanners typically include the scanning hardware (illumination and at least one camera) and may include the image capture software as well. The user is typically required to couple the scan head with a system for moving the object and/or scan head to create the different points of view necessary to create a 3D image. Calibration of the system is typically left to the user. The process of defining the points of view, e.g., camera/object relative positions, necessary to generate a complete 3D data set for an object is also typically up to the user and can involve substantial trial and error. The 3D data sets corresponding to a single object scan then need to be imported into the software that generates the 3D image of the object. The point cloud data may include extraneous data points, which must be “cleaned” before the data is used. The 3D image software typically has tools available that the user can select to clean the data.

The commercially available tools for generating 3D images of an object are not typically integrated into a user-friendly system which includes means for moving the object and/or camera. The software for data capture and the software for 3D image creation from captured data do not work together and commonly require the intervention of a very sophisticated user to plan and execute an accurate scan and then to process the resulting data to generate 3D files of the object. It is also common for users to want an inspection report comparing the measured dimensions of the scanned object to a planned CAD file or other specified standard. Such reports may be required by OEM manufacturers, U.S. Department of Defense, or agencies such as the FAA (for aircraft parts).

Typically, part inspection has been performed offline with a coordinate measuring machine (CMM), manually or with other inspection equipment. Removing the part from production equipment requires additional handling and setup of the part for inspection, making offline inspection a time consuming process. Further, offline inspection is not feasible for inspection of intermediate machine steps.

In an effort to increase accuracy, quality and productivity of manufacturing equipment, some machine tool manufacturers are offering on-machine inspection equipment. For example, it is known to incorporate contact inspection with probes into a CNC machine. This type of online inspection is complicated by inaccuracies of machine movement, which must be compensated for to obtain acceptably accurate measurements.

There is a need for a user friendly, cost effective, flexible and integrated system for scanning objects to generate accurate dimensional measurements of the object, 3D image files for reverse engineering and commercially acceptable inspection reports.

There is also a need for non-contact inspection methods and equipment that facilitate accurate inspection of parts during manufacture, allowing correction of parts before they are dismounted from the production equipment.

### SUMMARY

The disclosed structured light scanner comprises scanning hardware and control software. The scanning hardware includes a projector to illuminate the object, at least one camera to capture data from the object, and means for moving the camera and illumination relative to the object. Commercially available projectors can be employed in the proposed structured light scanner. A servo controlled two or three axis turntable is responsive to the control software and can be used for relatively small and easy to manipulate objects. For larger objects, it may be expedient to mount the projector and camera(s) on a servo controlled arm to move the projector and camera relative to the object. The disclosed control software includes scripts that communicate with the data capture software and 3D imaging software to coordinate the activities of these programs. The resulting system gives the user a single interface and enhances the capability of the existing programs with respect to image capture planning, data processing and report generation. The system can be customized through the interface for different objects, accuracies and reports.

### BRIEF DESCRIPTION OF THE DRAWINGS

FIG. 1 is a schematic view of representative 3D scanner hardware according to aspects of the disclosure;

FIG. 2 is a block diagram showing functional elements of the 3D scanner software with respect to the disclosed scanner control software;

FIG. 3 is a screen view of the home page of the disclosed scanner software showing the user interface and various functions available from the home page;

FIG. 4 illustrates a two axis platform with a part secured to the platform for scanning according to aspects of the disclosure;

FIG. 5 is an enlarged view of the platform and part of FIG. 4, showing the measurement of a “Z offset” of the center of the part relative to the platform;

FIG. 6 shows a representative support for a 3D scanner including a rail allowing movement of the 3D scanner along an axis toward and away from a part being scanned according to aspects of the disclosure;

FIG. 7 is a representative scan program developed by the scanner control software;

FIG. 8 is a flow chart illustrating functional steps in the disclosed scanning methods;

FIG. 8A is an alternative flow chart illustrating functional steps in the disclosed scanning methods;

FIGS. 9 and 10 are representative reports issued from the disclosed scanner system;

FIG. 11 illustrates deployment of a portable 3D scanner for use in conjunction with a CNC machine according to aspects of the disclosure;

FIG. 12 is a flow chart illustrating a procedure for calibrating the 3D scanner with respect to the CNC machine of FIG. 11;

FIGS. 13 and 14 illustrate a 3d scanner and calibration board used in the procedure of FIG. 12 in conjunction with the CNC machine of FIG. 11;

FIG. 15 illustrates a ball bar used to verify calibration and accuracy of a 3D scanner;

FIG. 16 is an enlarged view of the CNC machine of FIG. 11 showing a part fixture in the CNC machine and target spheres employed as references in the scanning procedure according to the disclosure;

FIG. 17 is a flow chart illustrating the steps carried out by the disclosed 3D scanner system to acquire data from an object using the CNC machine to manipulate the part; and

FIG. 18 is a flow chart illustrating operations carried out to process data acquired from a scan and produce a report of the results.

### DETAILED DESCRIPTION

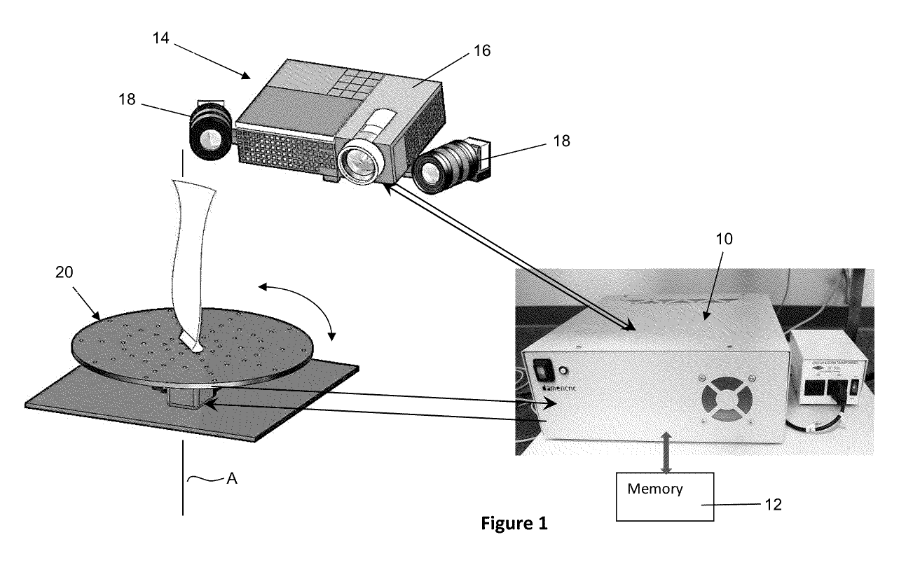

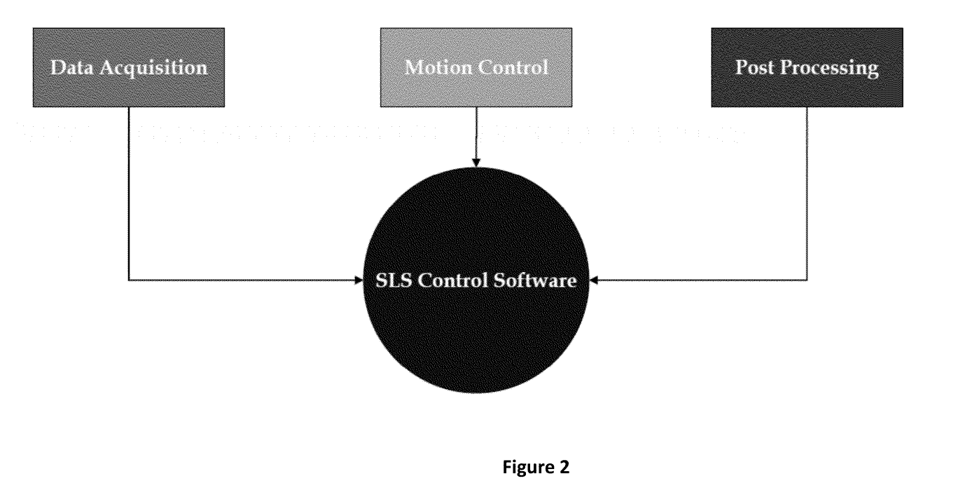

The disclosed structured light scanner (SLS) will be described with reference to FIGS. 1-18. The SLS includes hardware and software components. FIG. 1 illustrates representative scanner hardware including a computer 10 employed to store and run software, communicate with various hardware components, receive inputs from users, receive data from hardware, store scan programs, process data and produce reports of the scan and post processing analysis. The computer is equipped with typical user input/output hardware, such as a mouse, keyboard and monitor/display (not shown) to allow users to interact with the SLS control software. The computer includes on board memory 12 for storing software and data. A 3D sensor 14 includes a projector 16 and at least one camera 18. FIG. 1 illustrates a basic part support platform 20 in the form of a turntable configured to rotate about a single axis A. The SLS control software running on the computer 10 is configured to assist the user in setting up and calibrating the 3D sensor, creating scan programs for specific parts and coordinates the activity of the scanner hardware to acquire data about a part. As shown in FIG. 2, the SLS control software coordinates hardware and software operations relating to motion control, data acquisition and post processing of data.

With reference to FIG. 2, the SLS control software cooperates with commercially available software to accomplish some scanner functions. Data acquisition from images taken by the 3D scanner is handled by a program called Flexscan. Post processing of scan data is handled by Geomagic. The SLS control software provides a common user interface and automates transfer of data to and from the Flexscan and Geomagic programs. It will be understood that Flexscan and Geomagic are representative software programs and other programs may be suitable substitutes. The SLS control software provides the user with tools for creating, storing and running scan programs. The SLS control software also controls relative movement between the part and 3D sensor and capture of images at designated positions.

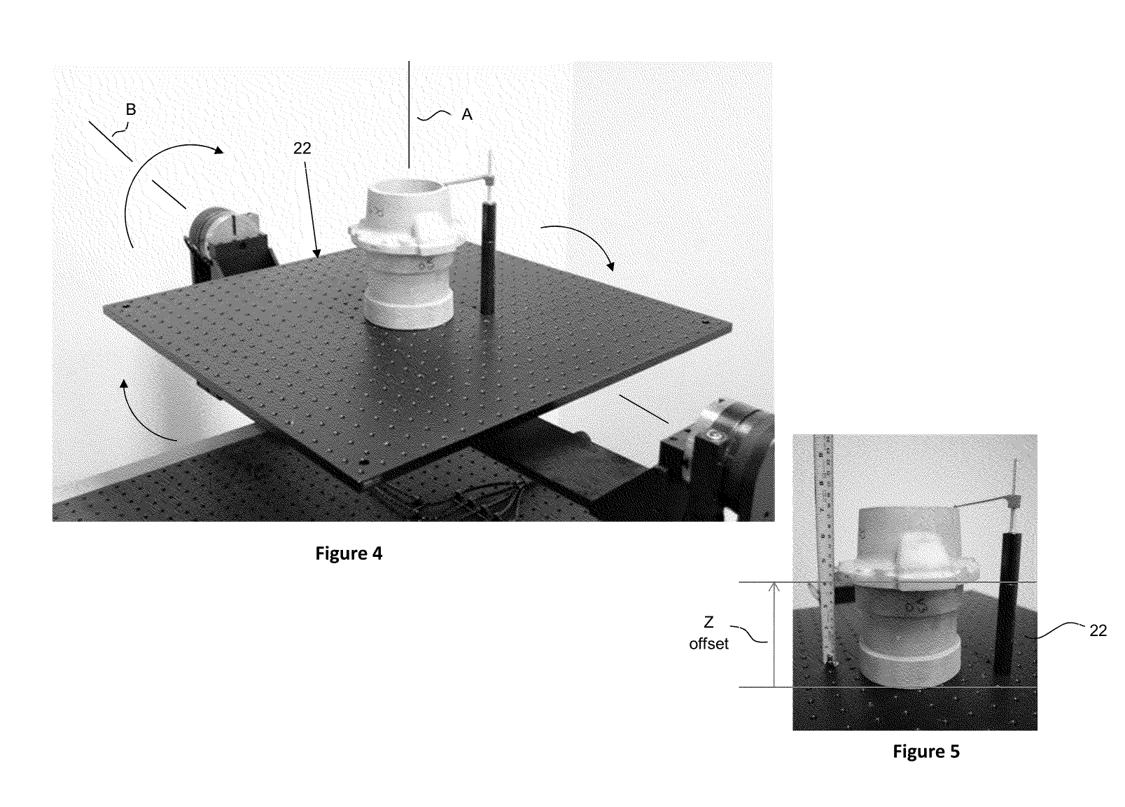

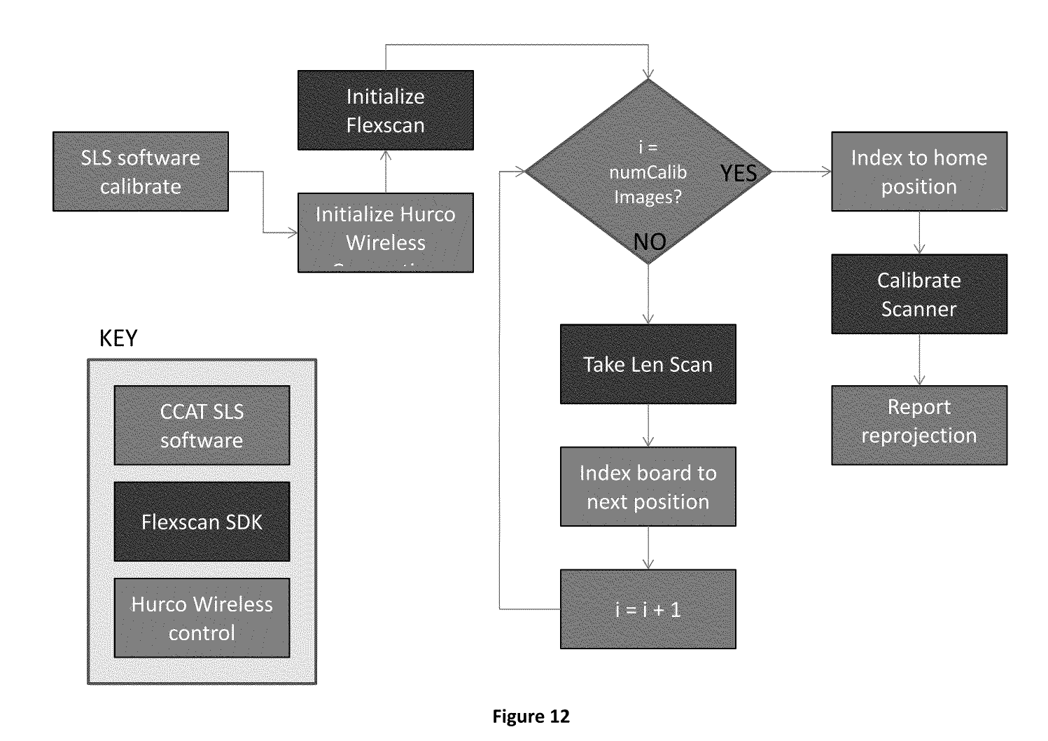

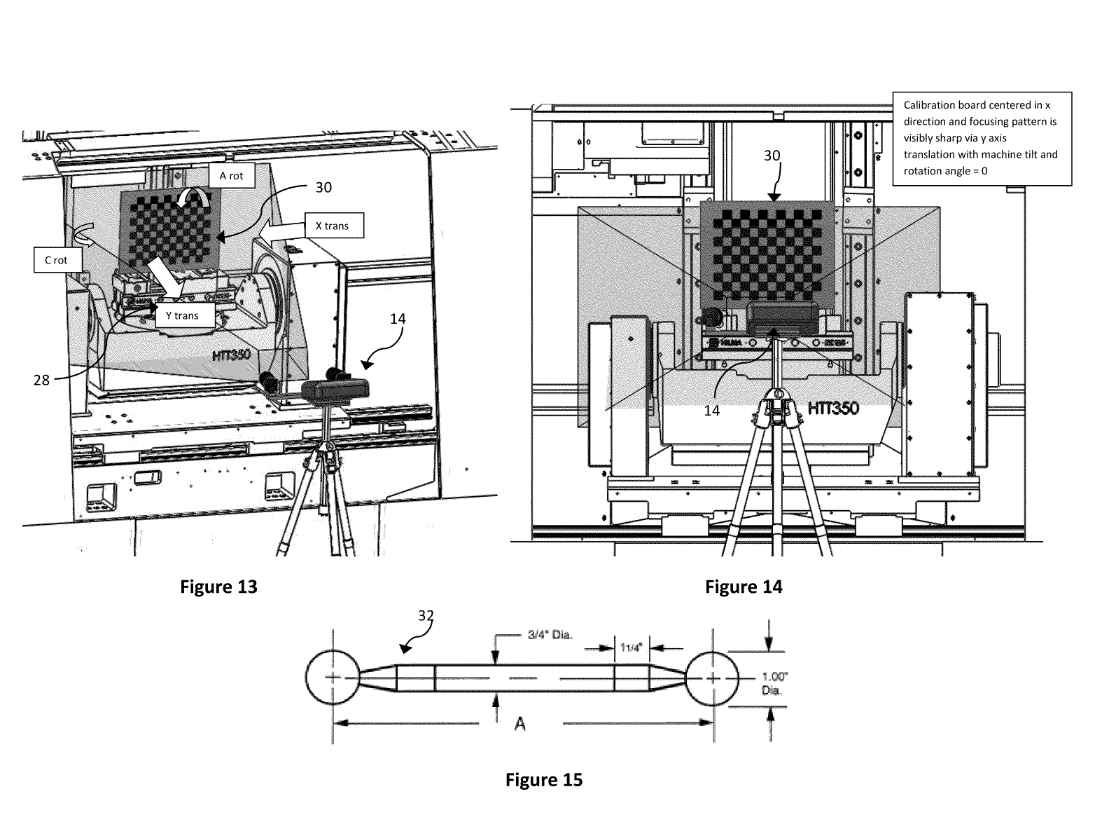

The scanner hardware must be calibrated to establish base-line relationships between the cameras 18 and the position of the part being scanned. Calibration is the process of setting up the hardware system so that the software knows what the offsets and angle settings are for the center of the part positioning device and between the cameras and the projector center of the field of view. These dimensions/relationships are used by the image/data capture software to calculate where points on the surface of the part being scanned are. FIGS. 12-14 illustrate a calibration procedure for use with an SLS for inspecting a part on a CNC machine, but the basic procedure is essentially the same for any iteration of the SLS. A calibration board 30 with a pre-determined checkerboard pattern on it is secured to the part moving component, which may be a stand-alone device as shown in FIGS. 1 and 4 or may be the part fixture surface of the CNC machine, as shown in FIGS. 13 and 14. The initial calibration position may also be referred to as the “home” position, corresponding to a position where the calibration plate surface is at the focal distance of the projector and cameras, so the pattern from the projector and the images taken by the cameras are both in focus. The home position also centers the calibration plate between the two cameras and in the center of each camera's field of view. A focusing pattern is projected onto the calibration board 30 and the projector is adjusted to bring the calibration pattern into sharp focus on the calibration board 30. The orientation and focus of each camera is adjusted to ensure they are focused on the same position and show the focused pattern projected on the calibration board. The part positioning device is then moved to its extreme positions and the process is repeated to ensure that the system will capture focused images of parts at all possible orientations of the part positioning device. Once the SLS is calibrated, it is typically sufficient to check the calibration using an abbreviated procedure.

To effectively image a complex three dimensional part, the part must be moved relative to the 3D sensor and images of the part taken from various vantage points so that the entire part may be re-constructed from the image data. The SLS software allows a user to develop a program to move the part to a sequence of positions to capture data from a part being inspected, and process that data into an accurate 3d rendering of the part. Path planning is setting up the motion of the part to be scanned relative to the projector (light source) and camera(s) via movement of the part positioning device, making sure that the complete part surface can be seen when the path is run for the inspection process. The SLS control software includes a user interface and software to quickly move the part around using a test path, and captures test images at each position to see if every portion of the part will be visible to the camera(s) in at least one position. During the path planning process, the SLS control software captures only representative images in the path planning mode, which speeds the path planning process.

The part positioning device 20 in FIG. 1 is a turntable, which allows rotation of the part about an axis A. The part positioning device 22 of FIG. 4 is a two axis table, permitting rotational movement of the part about two perpendicular axes A and B. Other part movements may be necessary depending upon the configuration of a part. It is possible to construct a part support surface of a transparent material that will allow images to be taken from a vantage point where the part support surface is between the part and the 3D sensor 14.

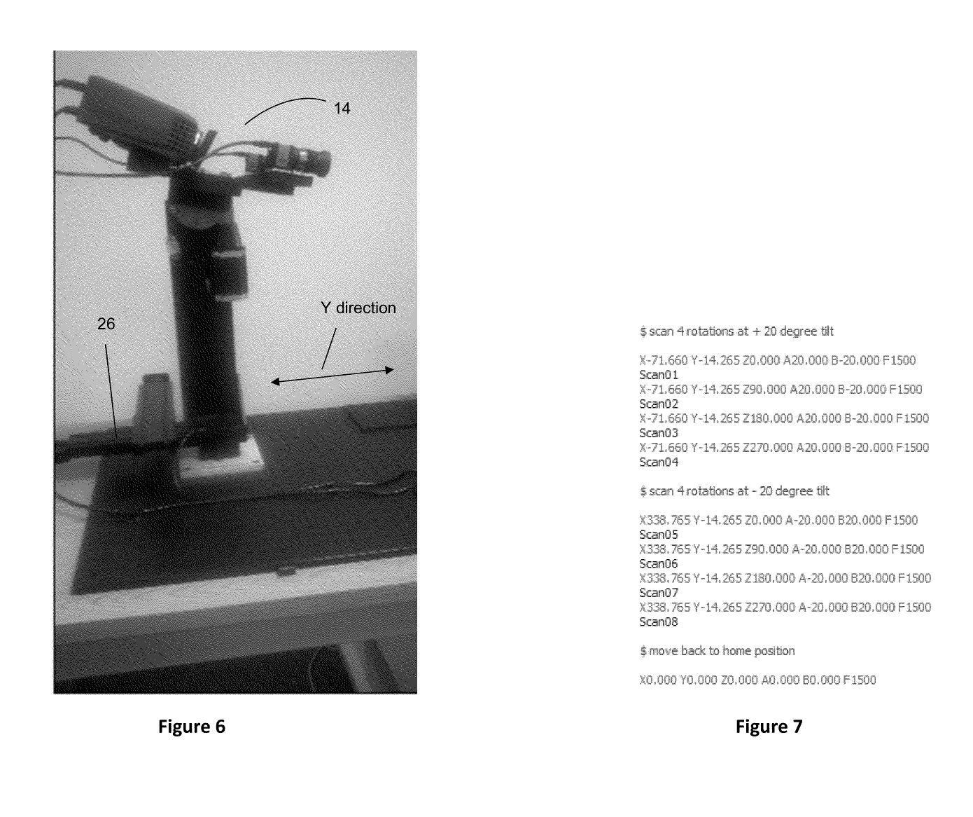

FIGS. 4 and 5 illustrate a part 24 fixtured to the part positioning device 22 for scanning. Part 24 has a significant height in the Z direction above the surface of the part positioning device 22. To maintain the surfaces being imaged at approximately the focus of the 3D sensor, it is necessary to measure the dimension of the part in the Z direction and input a Z offset of one half the height of the part. The SLS control software employs the Z offset to adjust the distance in a Y direction between the 3D sensor 14 and the center of the part positioning device. In the stand alone scanner configuration of FIG. 6, the 3D sensor 14 is mounted on a pedestal that is moveable in the Y direction on a rail 26. As best seen in FIG. 13, the workpiece support surface 28 of the CNC machine can be rotated about two perpendicular axes A rot and C rot as well as moved linearly along two perpendicular axes, Y (a horizontal direction toward and away from the 3D sensor 14 and X (a horizontal direction perpendicular to Y). The Z offset is used in either instance to adjust the distance between the 3D sensor 14 and the part being scanned to keep the part in focus when parts are tilted toward and away from the 3D sensor.

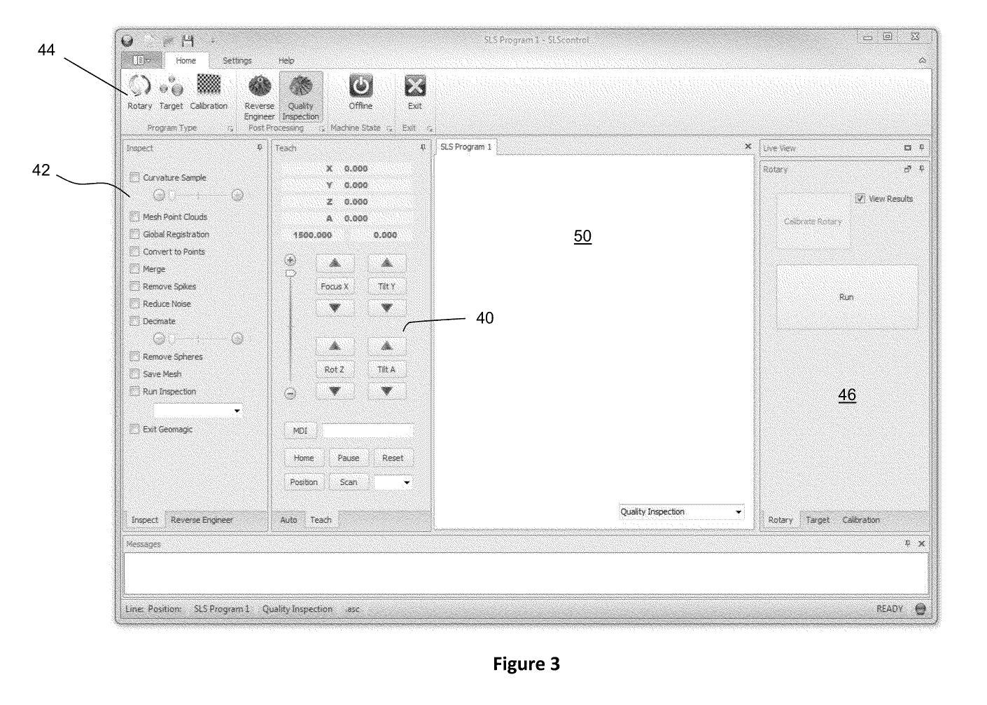

It will occur to those skilled in the art that each part may require a unique set of movements and images to capture all of the surfaces of the part. The disclosed SLS control software includes a module and user interface components that allow the user to create multiple scan path programs. On the home page shown in FIG. 3, panel 40 includes the options for path planning. The disclosed SLS software includes Teach and Auto Path options that generate the path program code for the user. Creating a scan program (path planning) in the Auto mode requires the user to input several scan parameters: a tilt angle (if any), the number of scans to take at each tilt angle, the speed of movement between scan positions and the Z offset (corresponding to the distance from the part support surface to the center of volume of the part being scanned). A tilt angle toward the 3D sensor is positive, while a tilt angle away from the 3D sensor is negative. The tilt stays constant until the required number of scans at that tilt angle have been taken. The number of scans to take at a certain tilt angle are equally spaced about the axis of rotation of the part. In the scan program example of FIG. 7, four scans are taken at each tilt angle, corresponding to rotational positions of 0°, 90°, 180° and 270°. In the Auto mode, the SLS control software converts the scan parameters into motion control scripts that are used to manipulate the part.

In the Teach mode, the user manually jogs the part positioning device with the 3D sensor on so the user can see what surfaces of the part are visible during movement. The user records positions at which a scan is to be taken and the SLS control software creates a motion control script corresponding to the movements and scan positions selected by the user. A more sophisticated user can manually type in the position and scan commands to create their own scan path program or add positions to a scan path developed by the SLS control software. The Auto and Teach modes may be used in conjunction to create a scan program. The SLS control software home page includes an MDI (multiple document interface) Container 50 (shown in FIG. 3), for organizing the scan programs for reference or later use.

FIG. 3 illustrates a screen shot of the home page for the SLS control software. The disclosed structured light scanner (SLS) software user interface is designed to track the menu and drop down appearance and functionality of Microsoft Office 2010. The home page is divided into vertical panels which allow a user to make selections and input variables. A horizontal ribbon control bar 44 allows a user to select the mode of operation from Rotary, Target, and Calibrate modes; select post processing treatment (either Inspect or Reverse Engineer) create, save, open new programs as well as the settings and help menu tabs. The post processing options panel 42 allows the user to select post processing treatment of scan data for either inspection or reverse engineering. The post processing options panel 42 also allows the user to make selections to reduce the quantity of data that must be processed and select options for how the data will be treated within the post processing software, such as Geomagic. The Teach and Auto path panel allows the user to select the mode for creation of a scan path as discussed above. The center of the home page includes a Program Editor/MDI container 50. The text corresponding to a scan path program is displayed here and can be edited. New or open programs are organized into tabs selectable at the top of Program Editor/MDI container 50. An execution panel 46 allows the user to select the mode of scan path program execution from Rotary and Target modes. Flexscan software captures the images and converts this to 3D point cloud data for each viewpoint, and saved in a folder as a file for each viewpoint. Geomagic software allows a user to manually do the following via an interactive session of mouse clicking: Import the data files, re-aligns them into a complete 3D image, merges them into a single file, meshes the points into an STL surface format, imports the CAD desired part data file, compares the captured data to the CAD data file, generates a color plot of differences, allows user to define dimensions to be measured, and calculates and records the measurement and whether the measured dimension is within the tolerance, and stores in an information array.

When the 3D sensor is calibrated and a scan path is prepared, the basic steps in scanning a part with the 3D scanner of the present disclosure are as follows: Fixture the part at the center of the part support surface (see FIGS. 1 and 4); Install target spheres as necessary (see FIG. 16); Select the mode of scan path program execution (rotary or target); Select the post processing treatment and variables (reverse engineering or inspection); Run the scan path program which moves the part to the scan positions, takes the scans at each position, stores the data corresponding to each scan, activates software to process the data for inspection or reverse engineering and produces a designated report showing the results of the scan.

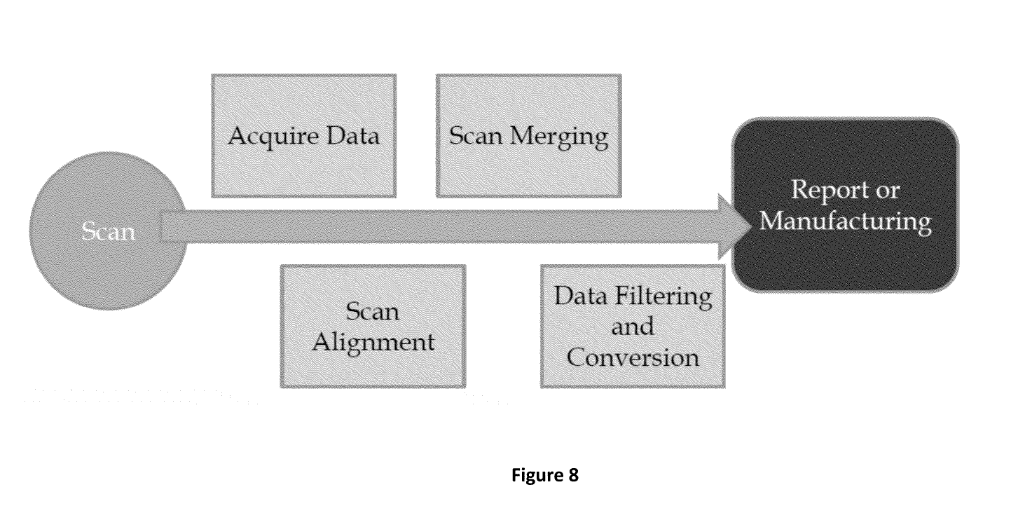

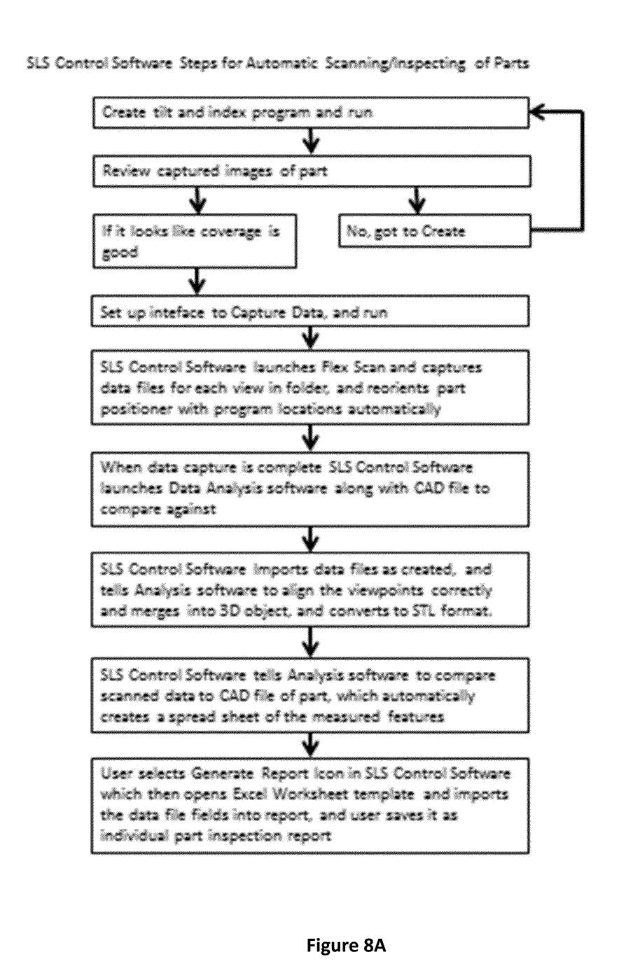

FIG. 8 is a simplified flow chart of the basic steps carried out during a scan according to the disclosure. Some of these functions are internal to the SLS software, while others are carried out in the Flexscan or Geomagic software via scripts activated from the SLS software. Scripts are activated from the user interface to carry out particular functions. Scripts may be written in Visual Basic, C+ or other program languages. Path planning and part movement are handled by the SLS control software. Data acquisition is handled by Flexscan. Scan alignment, merging, data filtering and conversion are handled by Geomagic. Data storage and transfer are generally handled by the SLS control software, as well as report generation. FIG. 8A is an alternative flow chart showing steps in the process of scanning a part with the disclosed SLS and SLS control software. The SLS software enhances user control of the complete inspection and/or reverse engineering process. Once a part is set up for the system, the SLS software executes the inspection process, collection of the data, comparison of the measured dimensions of a part to a CAD standard and the conversion of the measured feature data array into an Excel based AS9102 report format (or other formats) automatically.

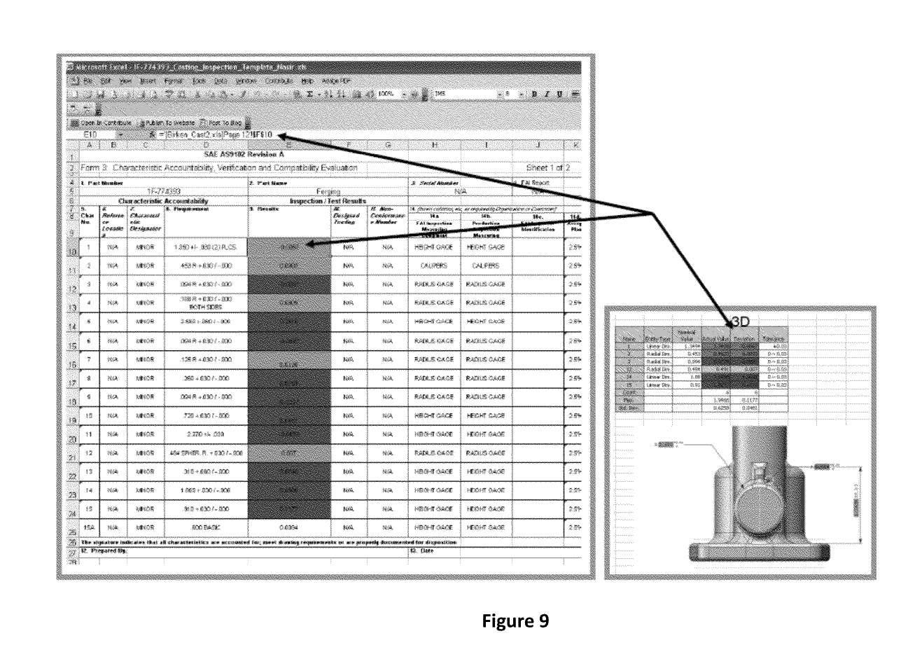

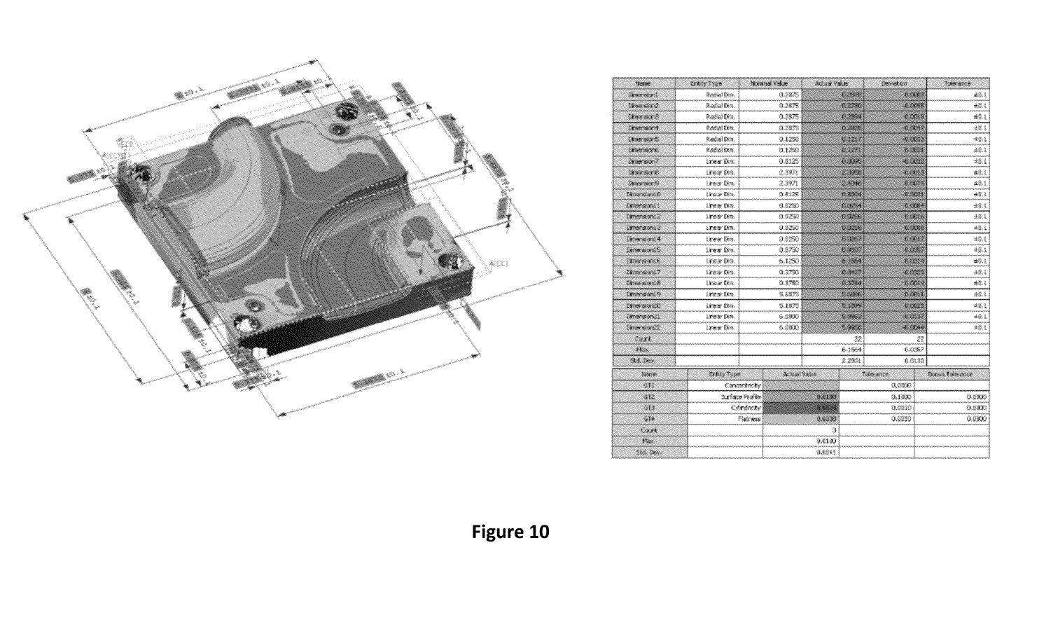

FIGS. 9 and 10 illustrate representative reports issued from the SLS control software. Each report includes a tabular presentation of measured data and may include a three dimensional image of the part being inspected. FIG. 10 includes a three dimensional image of the part with colors indicating portions of the part that are within and out of tolerance from the nominal (planned) dimension. Data can be exported in different formats and the use can select how the data is exported. Data can be exported to complete necessary inspection reports or into the user's proprietary inspection report. Once the desired formats are selected, data export, comparison and report generation are automatically handled from the SLS control software.

The SLS control software launches the Flexscan software to capture data, moves the part through a sequence of positions, capturing a data set for each position, then moves the part back to the original “home” position. The SLS control software then launches the Geomagic software and handles importing the data files into Geomagic, which re-orients the files on top of each other to make a single part file. Geomagic removes target and extraneous geometry and converts the cloud of points to an STL rendering. For an inspection, Geomagic imports the CAD file corresponding to the part being inspected, and then compares the measured part with the CAD file to create a 3D difference color plot. Geomagic captures the identified feature dimensions, and exports that to an ascii text file.

Many uses of the SLS scanner will require that inspected parts be accompanied by a detailed inspection report comparing the measured dimensions of the inspected part to a standard. Such reports may be required by an OEM manufacturer or by such agencies as the FAA (for aircraft parts). The SLS software routine simplifies the report generating process by populating the report with inspection data and activating the report generating function of the Geomagic software. The operator then closes Geomagic and from within the SLS control software generates an AS9102 Excel report (see FIG. 9) showing all the measurements and if the measurements comply to the nominal (planned) dimensions of the part.

An SLS scan will produce large volumes of data for each view of the part being scanned. Options available on the SLS user interface allow a user to reduce the quantity of data being processed to speed processing. The SLS software includes routines that reduce the number of data points. Examples of these routines are Curvature Sample and Decimate.

SLS Integration with CNC Machine

A further enhancement of the disclosed SLS allows the SLS to be integrated with a CNC machine to scan and evaluate a part while the part is still fixtured in the CNC machine. This permits the part to be scanned and inspected prior to being dismounted from the CNC machine. If further machining is needed, then the CNC machine can be used to correct any issues with the part, saving the time needed to dismount the part and remount the part in the CNC machine. Further, this arrangement allows the SLS to use the CNC machine to support and manipulate the part during scanning, eliminating the need for the SLS to have its own mechanism for fixturing and manipulating the part during scanning. In addition, the SLS control software can access the CAD file(s) for the part being machined/inspected, and so can compare the part as measured by the SLS, with the CAD file for the part stored on the CNC machine.

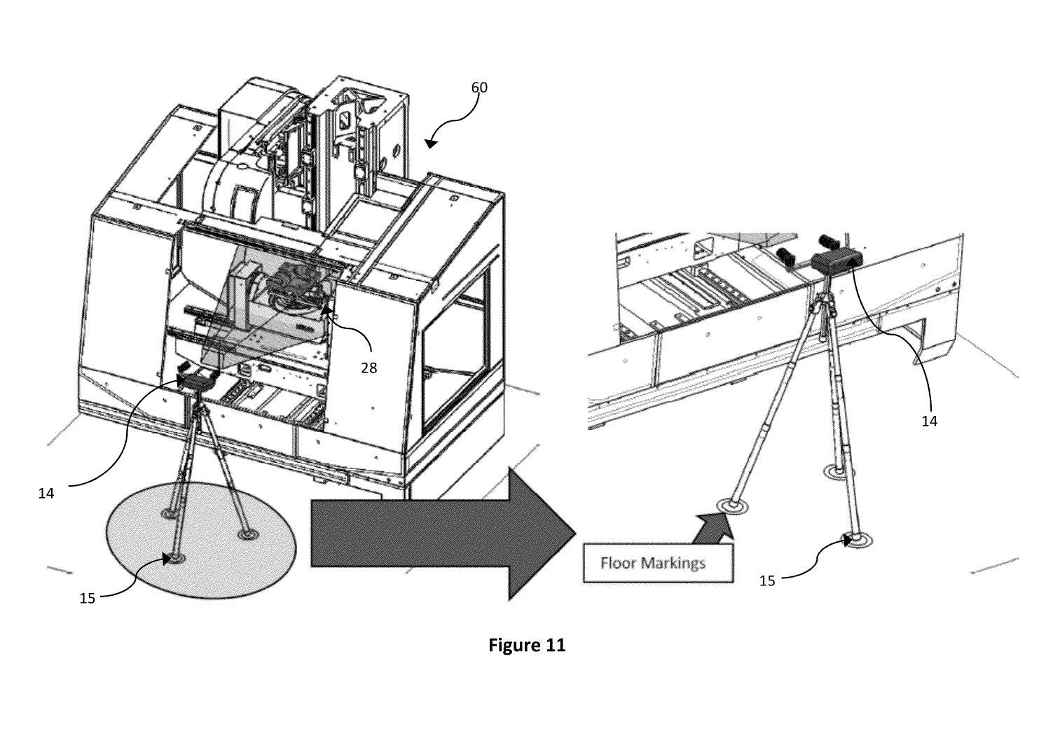

FIGS. 11-18 illustrate an embodiment of the SLS used in conjunction with a CNC machine 60 manufactured by Hurco Companies, Inc. The Hurco machine has a PC based controller (their own) and a mechanical configuration similar to the arrangement used to support parts for inspection in the disclosed stand-alone SLS illustrated in FIG. 1. Hurco's 5-Axis U-Series Computer Numerical Control (CNC) machines are designed with a trunnion style 4th and 5th axis that is fully integrated into their controllers. This allows high accuracy 5-axis positioning (4 axis part positioning, 1 axis spindle positioning) to machine complex, multi-sided parts with minimal part repositioning. A unique windows based controller along with full wireless capabilites allows remote communication with Hurco machines and simple software integration. As shown in FIG. 13, the Hurco machine moving axis configuration is substantially identical to the part positioning device shown in FIG. 4—a yoke that rotates around the horizontal axis (A rot), with a turn table on top of it (C rot). This simplified the programming necessary to manipulate the moving parts of the Hurco machine tool during calibration and scanning. With the Hurco PC controller, motion commands can be sent from the SLS control software on a system computer directly to the Hurco PC controller via a wireless connection. The Hurco controller was modified to accept commands from the SLS control software.

The Hurco part positioner configuration (4 axis of motion) easily presents various views of the part to the 3D sensor. This not only allows on machine inspection of the final cut part, but allows in process inspection to continually monitor the progress of the part through the various cutting cycles. In the disclosed method, a 3D sensor 14 is rolled up to the machine and communicates wirelessly to the machine controller to position the part in various orientations in order to capture whole part geometry, then runs through a quality inspection procedure to display a deviation color map to the user.

The Hurco U-Series controller is based on a windows platform having both wired network capabilities and wireless internet connection. The machine tool inlcudes an HTML interface for a user to send rapid move commands to the machine controller via a simple HTML form that is called by connecting to the machine IP address via any internet browser. Rapid move commands can be send to any one of the 5 axis independently or together for synchronized movement.

The disclosed SLS system is comprised of three major software components: Flexscan and its application programming interface (API); Geomagic and its application programming interface (API); and the SLS motion control, user interface and automation software (collectively, the SLS control software).

Flexscan functions are integrated and called from within SLS control software for scanner calibration, 3D data acquisition and data exporting. Geomagic functions are also integrated and called for post processing the data which involves (but is not limited to) data alignment, merging, cleanup and running a pre saved quality inspection program. Motion control components of the SLS control software are responsible for moving the part in various orientations in front of the 3D sensor 14 at a constant optimal distance from the 3D sensor 14 for highest accuracy data capture and maximum part coverage.

The integration of the Hurco machine involved adding Hypertext Transfer Protocol (HTTP) capabilities to the SLS control software. In principle, the Hurco controller acts as a server and the SLS control software acts as a client, sending a rapid move requests via http language addressed to the Hurco controller's IP address. In other words, the SLS control software internally “fills” Hurco's online rapid move request form and submits it to the controller.

In order to keep the part at optimal distance from the 3D sensor 14 regardless of the orientations the part will be put through or “Z offset” (distance between the table top and the volumetric center of the part), equations that compute the machine joint parameters that achieve specified positions of the end-effector, also known as inverse kinematics, are added to the motion control components of the SLS control software. The position each joint of the CNC machine needs to move to during the scanning process is automatically calculated given user-defined tilt angles, number of scans to take around the part at the tilt angle and the center of volume offset (Z offset) of the part relative to the trunnion table top 28.

Because the Hurco U-Series trunnion tables are designed such that the 5th axis rotary table top 28 is coincident with the 4th axis tilt rotation vector (A rot), the inverse kinemtic equations reduce to one simple trigonometry function which is needed for the y-axis to achieve optimal part to scanner distance:

y=d*cos(theta)

where: y=position of y-axis
d=center of volume offset of the part relative to the trunnion table top theta=tilt angle

The SLS scanner must be calibrated for use with a particular CNC machine as shown in FIG. 12 as follows: Put the machine in manual mode, start the Hurco WebService application from the Hurco software on the controller and open the part loading doors as shown in FIG. 11. Position the scanner tripod legs or wheels within the yellow area of the floor markings 15. Fix the checkerboard calibration plate 30 in the machine vise, turn on the scanner projector (if not already on) and change projection pattern to project the focusing pattern from the SLS software. With reference to FIGS. 13 and 14, jog the machine x,y translation axis and a,c rotation axis such that the scanner focusing pattern is visibly sharp on the calibration board and the focusing pattern center marker is centered within 0.5″ on the calibration board. Record the “home” position values for each axis in the SLS software.

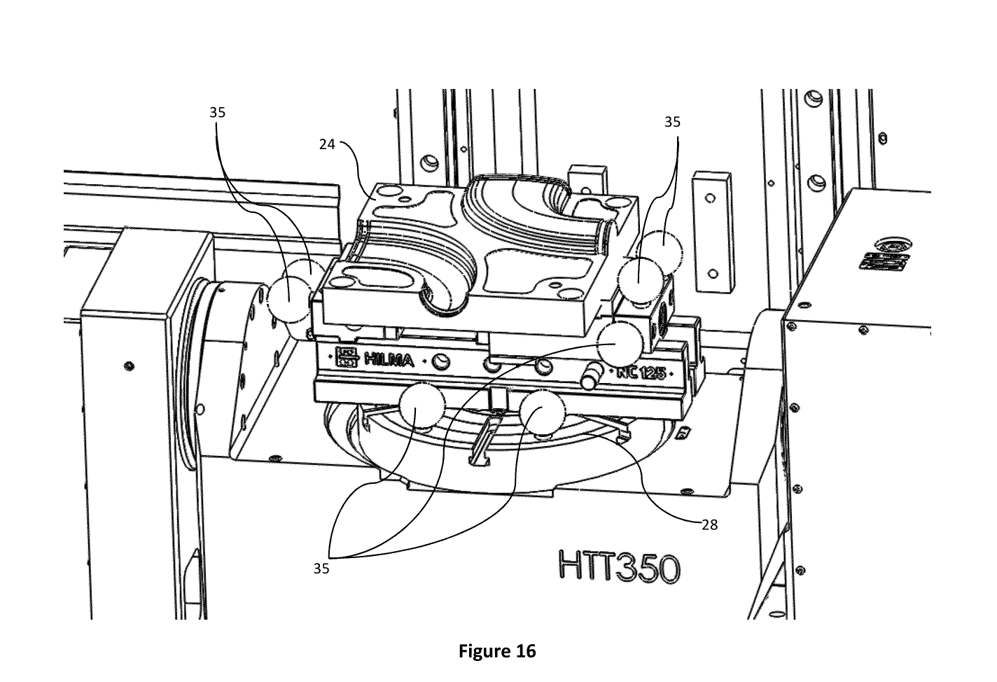

Run the scanner calibration routine from the SLS control software by clicking “Calibrate” in the SLS software interface (see FIG. 3). This will initialize both the wireless connection to the CNC machine and Flexscan software program. The CNC machine will translate and rotate the calibration board 30, stopping as the scanner takes calibration images (via Flexscan functions) through various positions. Once all the images of the calibration board are captured, the CNC machine will return to home position and the scanner will run through calibrating itself (via Flexscan calibration functions). During this process the physical relationship of one camera to another is established (extrinsic parameters) as well as and estimation of both camera lenses internal specs (intrinsic parameters). This calibration, called “scanner calibration” defines the accuracy of a single scan taken of an object. The single view scan is reconstructed to 3D space by triangulating between the two scanner cameras, hence the accuracy of the reconstruction is dependent primarily on knowing the exact spatial relationship of one camera to another. The optimal distance offset of the scanner to the part is also established during this “scanner calibration” procedure, which is the distance of the 3d sensor 14 from the part 24 that produces the most sharply focused image of the focusing pattern from the scanner projector on the part, and is also equal to the distance of the 3D sensor 14 from the calibration board 30 when the CNC machine is in the “home” position (as discussed above). At this point the 3D sensor and tripod is considered to be in calibration and ready for on machine inspection so long as neither camera nor projector lenses focus, zoom, or aperture are altered and the scanner “head” remains unchanged from the condition it was in during calibration. The 3D sensor 14 and tripod can be moved away from the CNC machine 60. A calibration check procedure is used to verify the accuracy of the scanner by using scanning a ceramic ball bar 32 (see FIG. 15) and comparing the measured distance between the center points of the spheres from scan data to the NIST certified measurement of the center point distance A.

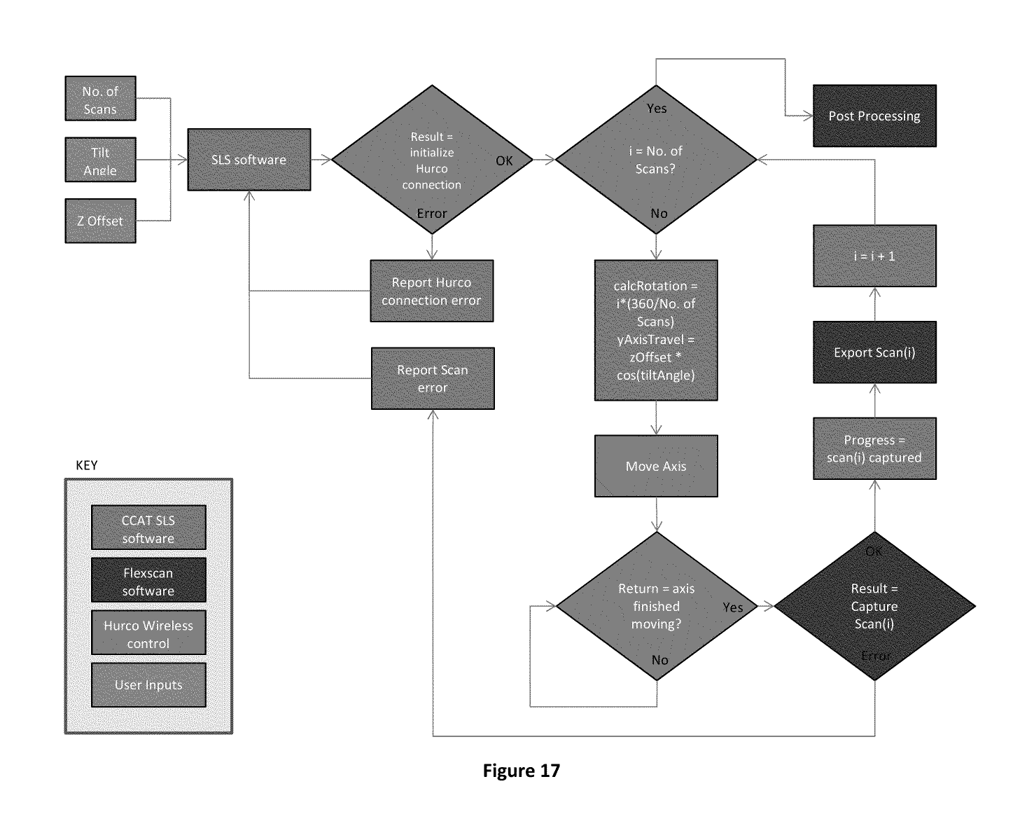

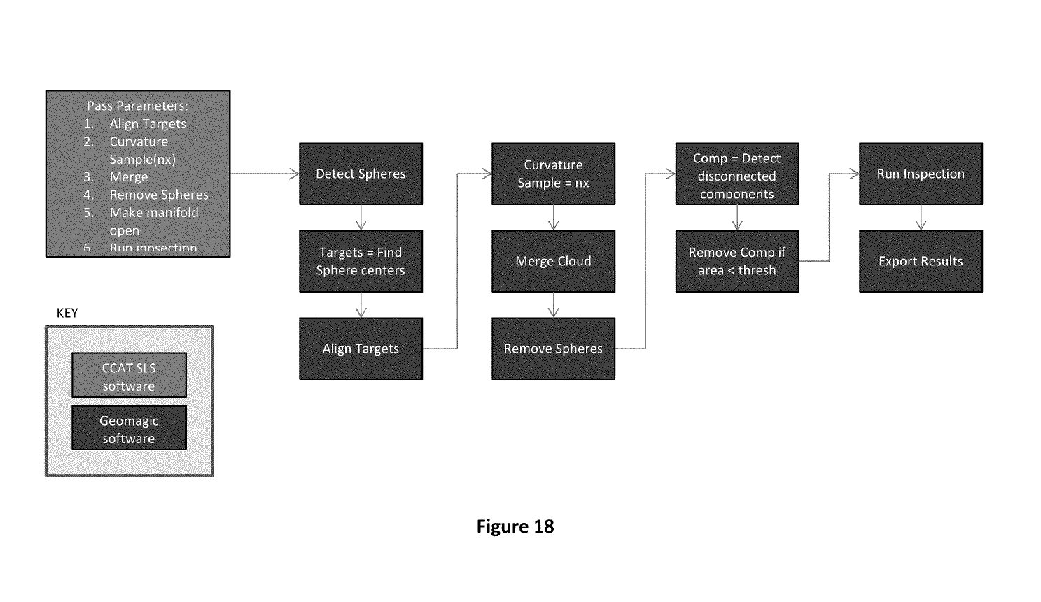

FIG. 17 illustrates steps for using the SLS to perform on-machine inspection according to the disclosure. Once calibration is performed\validated and a part has been machined, the CNC machine can be stopped and the doors opened. The 3D sensor 14 and tripod can be put in position in front of the CNC machine 10 as shown in FIG. 11. The part center of volume offset (+/−0.25″) from the trunnion table top 28 (Z offset) is measured and input into the SLS control software interface. Select home on SLS control software interface to have the CNC machine position the part in front of the scanner. The “home” settings are user defined values for x, y translation and a, b rotation of the CNC machine trunnion input during scanner calibration (as described above). With reference to FIGS. 16, 10-15 magnetic ceramic or white matte coated tooling balls 35 are randomly secured (magnetically or adhesively) to the CNC machine vise and table top 28. These spheres 35 will be used to register all captured single view 3D scans to form a complete 3D model of the part. Here, scans are not registered based on the CNC machine part transformations (as with conventional probe-based on-machine inspection), rather on the centers of the spheres 35 placed on the vise and the rotating platform of the Hurco machine. The registration based on targets is done via Geomagic functions as shown in the post processing flowchart of FIG. 18.

Choose a tilt angle and number of rotations and click scan. Doing this will initiate the following code logic:

for i = 0 to noOfScans −1
connect to hurco(“http://ipaddress/”)
wait for connection response
calcRotation = 360 / noOfScans
yAxisTravel = zOffset * cos(tiltAngle)
moveAxis = “http://ipaddress/x=” x “ y = ” y “ z = ” z “ a= ” tiltAngle
“c= ” calcRotation
* i
“ feedrate= ” feedrate “ execute= submit”
wait for finish move feedback
check cameras
captureScan(i)
write message “Scan” i “captured”
exportScan(i)
Next
start geomagic
import scans(geomagic)
run mesh processing(geomagic)
run inspection(geomagic)

The SLS control software will produce a report according to user specified criteria and format. The user can now check the deviation plot to determine whether the part passes or fails, and more importantly, if fails occur, where they occur and how much material needs to be removed to bring the part within specs. A part can be effectively inspected and corrected before removal from the production equipment, eliminating the delay and labor required for off line inspections.

The SLS and SLS control software should be compatible with other CNC machine tools, such as Fanuc, Mazak or Yasda. Some machine tools may not have a wireless communication channel available, so communications between the CNC machine tool and the SLS control software may be via a hard wired connection. In such a case the computer 10 would be hard wired to the CNC machine controller, and using the CNC machine libraries of software as the interface between the CNC machine and the SLS scanner computer 10.

In order to do the scanning on machine, the following process is used:
a. Finish machining process and open the door of the machine.
b. Spray the part dry with air hose
c. Attach tooling balls on the work holding fixture
d. Spray on “talcum powder” to dull the surface finish
e. Roll up scanning head mounted on an industrial tripod
f. Plug Scanner controller into machine controller (or establish wireless communication link)
g. Use Scanner controller computer to capture the data, control the motion of the part to new positions with machine controller, process the data the same as with standalone systems.

Typically, machined parts are shiny which makes them hard to scan. The disclosed methods will require that the parts be blown dry (most machines have an air hose available for blowing chips away), and then spray on talcum powder to dull the surface. The talcum (or other white powder) then washes off as new lubricant flows over the part and tool during subsequent machining.

With the disclosed SLS control software, it is possible to coordinate the capture of data, movement of the part on the CNC machine between scanning positions, the data processing of the actual part data collected, compared to the CAD file, and the creation of the AS9100 inspection report. All of these functions are linked together as a working system with a single user interface.

### Alternative SLS Configurations

The SLS system is modular and flexible, allowing for different SLS configurations for different measurement and inspection purposes. Systems may be configured with different 3D sensors including one or more cameras, depending upon the specific scanning project. The SLS may be equipped with various part positioning device having one, two or more axes of movement, depending upon the complexity of the objects being scanned. If the part is small, it makes sense to move the part relative to the 3D sensor. If the part is large, it may be necessary to move the 3D sensor relative to the part being scanned. FIG. 1 illustrates a system with one scanner head, where the system has one axis of motion for moving the part. Multiple 3D sensors may be employed in a multi-sensor SLS system configured to scan an object from above and below at the same time, with the object positioned on a transparent turntable (not shown). The SLS can be configured with as many as four sensors. Various combinations of 3D sensors, and part positioning devices will occur to those skilled in the art.

What is claimed is:

1. A non-contact inspection system for use in conjunction with a computer controlled machine tool, said machine tool having a part positioning table mounted for movement about two axes, a controller to define the position of said table and a communications interface allowing transfer of position information to said controller, said non-contact inspection system comprising:
a 3D sensor having a pre-determined position relative to a workpiece mounted on the table, said 3D sensor including a light source and at least one image capture device;
an inspection control computer including a user interface, a memory a position control interface for delivering position information from said inspection control computer to the controller across said communications interface, and at least one inspection program stored in said memory, each said inspection program including position information corresponding to a plurality of workpiece positions relative to said 3D sensor,
wherein said inspection control computer delivers position information to the controller, which moves the table to each workpiece position and said inspection control computer actuates said 3D sensor to capture an image of said workpiece at each said workpiece position.

2. The non-contact inspection system of claim 1, wherein said inspection control computer includes software for assembling data from said images of said workpiece into a 3 dimensional model of said workpiece.

3. The non-contact inspection system of claim 2, wherein said computer controlled machine tool includes a drawing of the workpiece and said inspection control computer compares the 3 dimensional model of the workpiece to said drawing and prepares a report showing where said model deviates from said drawing.

4. The non-contact inspection system of claim 1, comprising means for moving said 3D sensor relative to said workpiece along at least one axis.

5. A method for inspecting a workpiece being machined on a computer controlled machine tool where the machine tool includes a workpiece positioning table mounted for movement about two axes, a controller to define the position of said table and a communications interface allowing transfer of position information to said controller, said method comprising:
performing at least one machine operation on said workpiece;
arranging a 3D sensor at a pre-determined position relative to said table;
connecting an inspection control computer to said 3D sensor and said controller, said inspection control computer having memory and at least one inspection program stored in said memory, each said inspection program including position information corresponding to a plurality of workpiece positions relative to said 3D sensor;
delivering position information from said inspection program to said controller so that said controller moves said table to each said workpiece position;
capturing an image of said workpiece at each said workpiece position;
assembling data from said images of said workpiece into a 3 dimensional model of said workpiece.

6. The method of claim 5, wherein said computer controlled machine tool includes at least one CAD drawing of the workpiece and said method comprises:
comparing said model to said CAD drawing; and
generating a report showing where said model deviates from said CAD drawing.

7. The method of claim 6, comprising:
using said report of deviations from said CAD drawing to instruct said machine tool to perform additional machine operations on said workpiece to eliminate said deviation.
